(19) United States
(12) Patent Application Publication
(10) Pub. No.: US 2022/0379854 A1
(43) Pub. Date: Dec. 1, 2022

(54) TRAILER BRAKE CONTROLLER AND ITRM BOO INTERFACE

(71) Applicant: HORIZON GLOBAL AMERICAS INC., Plymouth, MI (US)

(72) Inventor: Chandrakumar KULKARNI, Plymouth, MI (US)

(21) Appl. No.: 17/770,322

(22) PCT Filed: Oct. 23, 2020
(86) PCT No.: PCT/US2020/057095

§ 371 Date: Apr. 20, 2022

Related U.S. Application Data
(60) Provisional application No. 62/924,887, filed on Oct. 23, 2019.

(51) Int. Cl. B60T 8/17; B60Q 1/30; B60Q 1/46

(52) U.S. Cl. CPC B60T 8/1708; B60Q 1/305; B60Q 1/46

(57) ABSTRACT

A trailer brake system may include a trailer brake controller comprising a manual braking control, and a trailer light controller; where the trailer brake controller comprises a brake on/off relay, which responds to the manual braking control.

### CROSS-REFERENCE TO RELATED APPLICATIONS

The present application claims priority to and the benefit of U.S. Provisional Patent Application 62/924,887 titled “TRAILER BRAKE CONTROLLER AND ITRM BOO INTERFACE,” filed on Oct. 23, 2019, the entire disclosure of which is incorporated by reference herein in its entirety.

### TECHNICAL FIELD

This disclosure relates to a trailer light control device, system, and method for controlling the brake lights of a towing vehicle or towed vehicle. More specifically, a trailer module with a brake on/off line interface that controls the indicator lights of vehicle is described herein.

### BACKGROUND

A variety of aftermarket trailer brake controllers may be employed to control the brakes of a towed vehicle. Typically, the brake controller may actuate the towed vehicle's brakes in response to braking by the towing vehicle. These brake controllers may often include accelerometers and microprocessors which may measure and/or take into account a variety of conditions (e.g., braking signal, acceleration, etc.), whereby the brake controller may apply the towed vehicle's brakes in such a manner that assists in stopping the towing vehicle and towed vehicle, and may also increase the safety of driving conditions.

The brake controller is often mounted to the towing vehicle. Typically, the brake controller may be hard-wired to the towing vehicle, such as being mounted in the cab or passenger compartment of the towing vehicle. The brake controller may communicate with the brake system of the towed vehicle by a wiring system that may provide communication between the towing vehicle's brake system and the towed vehicle's brake system.

Brake controllers can also receive input from a user to manually actuate the trailer brakes. For examples, a user may press a button, move a slidable control, or interact with another interface on a brake controller. The brake controller will then manually actuate the brakes of the trailer. Brake controllers, however, may not always control the brake lights on a trailing vehicle or other lights on a vehicle, such as a center-high mounted stop light (CHMSL).

Therefore, there is a need in the art for a trailer light control device, system and method that appropriately controls lights on one or more vehicles.

### SUMMARY

The present disclosure includes a system, method, and devices related to data collection and communication of the performance of various vehicle accessories and systems. These accessories and systems are described in detail below, and any combination of elements and/or methods are contemplated as aspects and embodiments of the overall invention.

A trailer system includes a trailer brake controller and a trailer light controller. The trailer brake controller may control the trailer brakes of a towed vehicle. The trailer light controller may control lights of a towed or towing vehicle. The trailer braking control module and lighting module appropriately controls trailer lighting during manual activation of trailer brakes.

A method includes providing a trailer system comprising a trailer brake controller and a trailer light controller. The method may control the trailer brakes of a towed vehicle and one or more lights of a towed or towing vehicle. The method appropriately controls trailer lighting during manual activation of trailer brakes.

In one aspect of the invention, a system may comprise a trailer brake controller, which comprises a manual braking control and a trailer light controller wherein the trailer brake controller comprises a brake on/off relay, which responds to the manual braking control. In a further aspect to any other aspect, the trailer brake controller comprises an electronic device that controls the brakes of a trailer. In a further aspect to any other aspect, the trailer brake controller is included in a towing vehicle or in a trailer. In a further aspect to any other aspect, a user interface component is included in the trailer brake system wherein the user interface component is in communication with the manual braking control in a towing vehicle or trailer and is configured to receive an activation instruction from the manual braking system when activated by a user. In a further aspect to any other aspect, the user interface component is configured to further communicate a signal to the brake on/off relay. In a further aspect to any other aspect, the signal is one that closes the brake on/off relay thereby allowing the signal to further communicate with at least one light on a trailer. In a further aspect to any other the trailer light controller comprises a power circuit, an anti-feedback circuit and a sensing circuit. In a further aspect to any other aspect, the anti-feedback circuit is connected, in series, between the power circuit and the brake on/off relay. In a further aspect to any other aspect, the anti-feedback circuit comprises a diode.

A further aspect of the invention includes a process for using a trailer brake system comprised of a trailer brake controller and a trailer light controller, wherein the process comprises, from a towing vehicle, initiating a braking signal to the trailer brake controller to apply a trailers brakes, wherein the braking signal is received by a user interface in the trailer brake controller which communicates the braking signal to the brakes of a trailer and communicates the braking signal to a brake on/off relay, wherein the brake on/off relay, upon receiving the braking signal, closes, thereby sending a signal to at least one brake light on a trailer to indicate braking is being applied to the trailer and lighting the brake light. In a further aspect, the trailer light controller comprises a power circuit, an anti-feedback circuit and a sensing circuit. In a further aspect to any other aspect, the anti-feedback circuit is connected, in series, between the power circuit and the brake on/off relay. In a further aspect to any other aspect, the anti-feedback circuit comprises a diode. In a further aspect to any other aspect, when the brake on/off relay is closed, the anti-feedback circuit in the trailer light controller prevents flow of current from the trailer brake controller to the trailer light controller. In a further aspect to any other aspect, when the braking signal is not present, the brake on/off relay opens and the brakes on the trailer are not applied and the brake light on the trailer is not activated. In a further aspect to any other aspect, the trailer light controller communicates with and controls lights on the trailer. In a further aspect to any other aspect, the lights on the trailer include brake lights on the trailer. In a further aspect to any other aspect, the lights on the trailer include a center high mounted stop light (CHMSL).

A system may include a trailer brake controller that comprises a manual braking control and a trailer light controller. In the system, the trailer light controller is configured to turn on a stop light of a trailer lighting system or towing accessory lighting system when the manual braking control is not activated. The system may further comprise a sensing circuit operatively coupled with either of the trailer brake controller and/or the trailer light controller, wherein the sensing circuit senses a status of the manual braking controller. More specifically, in the system the sensing circuit may be integrated into the trailer light controller.

The foregoing embodiments are merely exemplary of some of the aspects of the system. Additional features and elements may be contemplated and described herein. Also, features from one of the foregoing embodiments may be combined with features from any of the other foregoing embodiments.

### DESCRIPTION OF THE DRAWINGS

FIG. 1 is a functional schematic diagram of a trailer light control module of the present disclosure;

FIG. 2 is a functional schematic diagram of a trailer light control module including a feedback prevention circuit and a current sensing circuit of the present disclosure; and

FIG. 3 is a FET drive signal from microprocessor of the trailer light control module of FIG. 2.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device. Furthermore, the terms “user,” “customer,” “consumer,” and the like are employed interchangeably throughout the subject specification, unless context suggests otherwise or warrants a particular distinction among the terms. It is noted that such terms may refer to human entities or automated components supported through artificial intelligence (e.g., a capacity to make inference). As such, embodiments may describe a user action that may not require human action.

As used herein, a towing vehicle may include various types of automobiles (e.g., car, truck, recreational vehicle (“RV”), etc.). A towed vehicle may include trailers (e.g., agricultural trails, boat trailers, etc.), an automobile, truck bed slide in items such as campers, toolboxes, utility boxes, or the like. It is noted that various combinations of towed vehicles and towing vehicles may utilize some or all aspects of this disclosure. In another aspect, different makes and models of towing and towed vehicles may include different or additional lights. As such, it is noted that examples may reference a particular light or set of lights, while embodiments may control other or different lights.

Disclosed embodiments may refer to a brake controller, brake controller device, trailer brake controller module, trailer brake controller or the like. Such terms are used interchangeably to describe electronic devices that control the brakes of a trailer or towed vehicle. For instance, a brake controller may comprise a unit that is mounted in or on a towing vehicle or provided as a directly manufactured in the towing vehicle. The towing vehicle is attached to a towed vehicle (e.g., via a hitch or the like). The towing vehicle may pull, push, or otherwise tow the towed vehicle. The brake controller system may monitor acceleration and application of a brake pedal to control the brakes of the towed vehicle to operatively apply (e.g., engage, release, etc.) the towed vehicle brakes. Moreover, while embodiments may refer to a brake controller system comprising various components, such components may be a single device or multiple devices in communication with each other. For example, a brake controller may include a display, a processing unit, and an accelerometer. These components may be comprised within a single housing or in multiple housings. The components may include wiring, circuitry, or the like. In at least one embodiment, a brake controller may be mounted in or on a towing or towed vehicle. Other components may include anti-sway devices, converters, trailer breakaway systems, tire pressure monitoring systems for trailers, vehicle speed monitoring systems, user equipment devices, internet or network connected devices, external cameras, and the like.

Disclosed embodiments may include user interfaces. As used herein, a user interface may include devices that receive input from a user and transmit the input to electronic circuitry, such as a microprocessor, or output information from electronic circuitry to a user. Such user interfaces may include buttons, switches, knobs, touch screens (e.g., capacitive touch screens), microphones, image capturing devices, motion sensors, pressure sensors, a display screen, a speaker, a light (e.g., LED, bulb, etc.), or the like. For brevity, examples may be described with reference to a user interface in general rather than any particular type of user interface. It is noted that brake controllers may include multiple user interfaces of various types.

In traditional brake controllers, users may manually control the brakes of a trailing vehicle through a user interface. For instance, a user may slide a switch that controls a potentiometer. The position of the potentiometer may be utilized to initiate a manual braking algorithm that overrides other braking algorithms. The position of the potentiometer may additionally control the amount of braking force in the trailer brakes. Some traditional brake controllers may not be able to control one or more lights of the towing or towed vehicle when the manual braking algorithm is controlling the trailer brakes.

Disclosed herein are trailer light control devices, systems, and methods that may control one or more lights of the towing or towed vehicle when the user manually controls the trailer brakes. In an aspect, a trailer light control device may be integrated within the original equipment manufacturer's towing vehicle, within a towed vehicle, or as an aftermarket device. Specifically, the trailer brake control module may operate in conjunction with the trailer lighting module such that when the trailer brake controller module activates the stop light on the towed vehicle lighting system (such as when the trailer brake control module is manually activated) and/or accessory lighting system, the lighting module won't turn on the stop light on the towed vehicle lighting system and/or accessory lighting system. This particularly occurs when the manual braking on the trailer brake control module is activated. This will help prevent the lighting system from becoming overheated and prevent the lighting system module from activating the trailer/towed vehicle brakes.

The system may include a trailer brake controller that comprises a manual braking control and a trailer light controller. In the system, the trailer light controller is configured to turn on a stop light of a trailer lighting system or towing accessory lighting system when the manual braking control is not activated. The system may further comprise a sensing circuit operatively coupled with either of the trailer brake controller and/or the trailer light controller, wherein the sensing circuit senses a status of the manual braking controller.

More specifically, in the system the sensing circuit may be integrated into the trailer light controller.

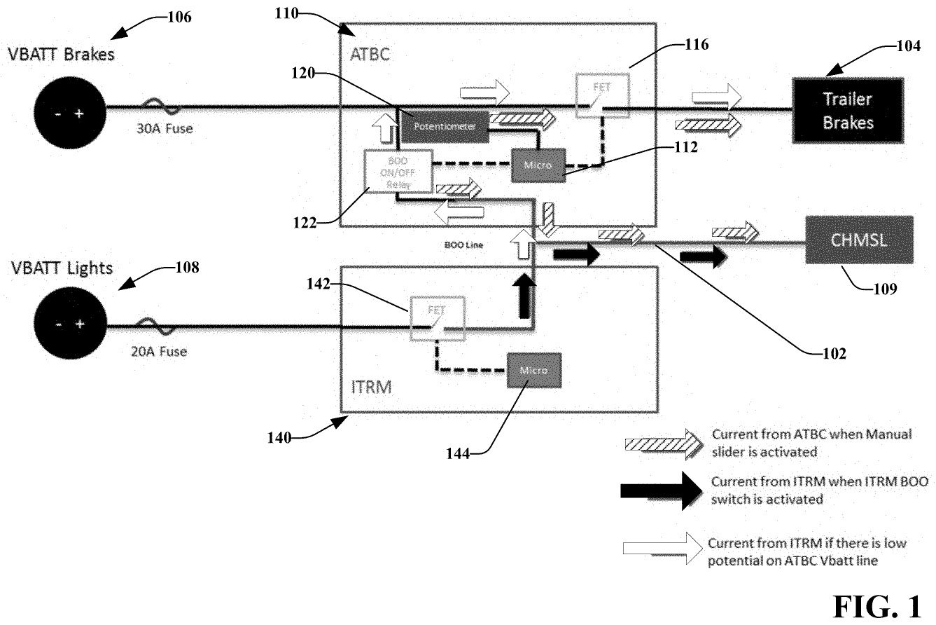

Turning now to FIG. 1, there is a functional block diagram of a trailer system 100 including a trailer brake controller 110 and a trailer light controller 140. The trailer brake controller 110 may control the trailer brakes of a towed vehicle in accordance with various disclosed embodiments. As described herein, the brake controller 110 may be a proportional or inertia based system, timer system, or other system. Exemplary, non-limiting brake controller units are disclosed in U.S. Pat. Nos. 6,012,780; 6,068,352; 6,282,480; 6,445,993; 6,615,125; 8,746,812; 8,789,896; and 9,150,201.

The brake controller 110 may include a processor 112 (e.g., microprocessor, microcontroller, etc.) coupled to or including a memory that may store computer executable instructions which may be executed by the processor 112. The brake controller 110 may further include a power control circuit 116 that may include, for example, a Fluid Effect Transistor (FET) that operatively supplies power to trailer brakes 104 from a brake battery source 106 (VBATT Brakes). In another aspect, the brake controller may include a manual brake user interface 120. The manual brake user interface 120 may include, for example, a potentiometer that may allow a user to manually control the power supplied to the towed vehicle's brakes through the power control circuit 116. In embodiments, brake controller 110 may include or interact with a brake on/off (BOO) relay 122. It is noted that the processor 112 may be coupled to the power control circuit 116, interface 120, BOO relay 122, and other components of the brake controller 110.

The processer 112 may control the BOO relay 122 and may turn the BOO relay 122 to an on or off state. Based on the state of the BOO relay 122, the brake controller 110 may send a signal along a BOO line 102. The BOO line 102 may be coupled to at least one light on a trailer, a portion of the lights on the trailer or all of the lights on the trailer. Trailer lights include, but are not limited to, by way of non-limiting examples, lights on a towed trailer or lights on a towed vehicle, such as a center-high mounted stop light (CHMSL) 109, lights in a truck bed insert such as on a truck bed cover, camper, tool container, utility container, or the like. In one particular embodiment, the CHMSL 109 may be controlled by the trailer brake module of the invention. In another embodiment or in addition, the trailer lights may be controlled by the trailer light module/trailer light controller of the invention. In either case, the trailer brake lights alone or in combination with a CHMSL 109 may be controlled by the lighting control module and/or the trailer brake control module. Moreover, the lighting module system may control the lights. The trailer light controller/module 140 may control the lights of the towed vehicle or towing vehicle, including auxiliary systems attached thereto, such as through the BOO line 102. The trailer light controller 140 may be coupled to a lights power source 108 (VBATT Lights). The lights power source 108 may supply power to a power circuit 142 of the trailer light controller 140. The power circuit 142 may include a FET or other circuitry. In another aspect, the trailer light controller 140 may include a processor 144 (e.g., microprocessor, microcontroller, etc.) coupled to or including a memory that may store computer executable instructions, which may be executed by processor 144.

In embodiments, when the manual brake user interface 120 is activated (e.g., when a user actuates manual braking thereby sending an activation instruction to the user interface), the trailer light controller 140 may not identify that the manual braking is activated or otherwise act so that it may not activate one or more lights. Accordingly, the brake controller 110 will close the BOO relay 122 when manual brake user interface 120 is activated. This allows current to flow from the brake controller 110 to the BOO line 102. The BOO line 102 may couple the brake controller 110 to one or more lights, such as center-high mounted stop light 109 (and/or trailer lights or a portion thereof), such that the signal from the brake controller 110 flowing through the BOO line 102 drives connected lights. This may allow the trailer system 100 to indicate that the towed or towing vehicle is stopping or otherwise applying braking force. Further, it prevents the trailer light controller 140 from activating the lights/lighting system already activated by the brake controller 110. This prevents the lighting system from overheating and can prevent the towed vehicles brake from being unintentionally applied.

It is noted that the current flowing from the brake controller 110 to the BOO line 102 may also flow into the trailer light controller 140, and specifically into the power circuit 142. The brake power source 106 may be greater generally than the lights power source 108. As such, the power circuit 142 should be large enough to handle the signal from brake power source 106. For instance, the power circuit 142 should include a larger FET than needed to handle input from the lights power source 108. If the FET is not large enough to handle the signal from the brake power source 106, the signal may overheat the trailer light controller 140, damage the FET or may otherwise render the FET inoperable.

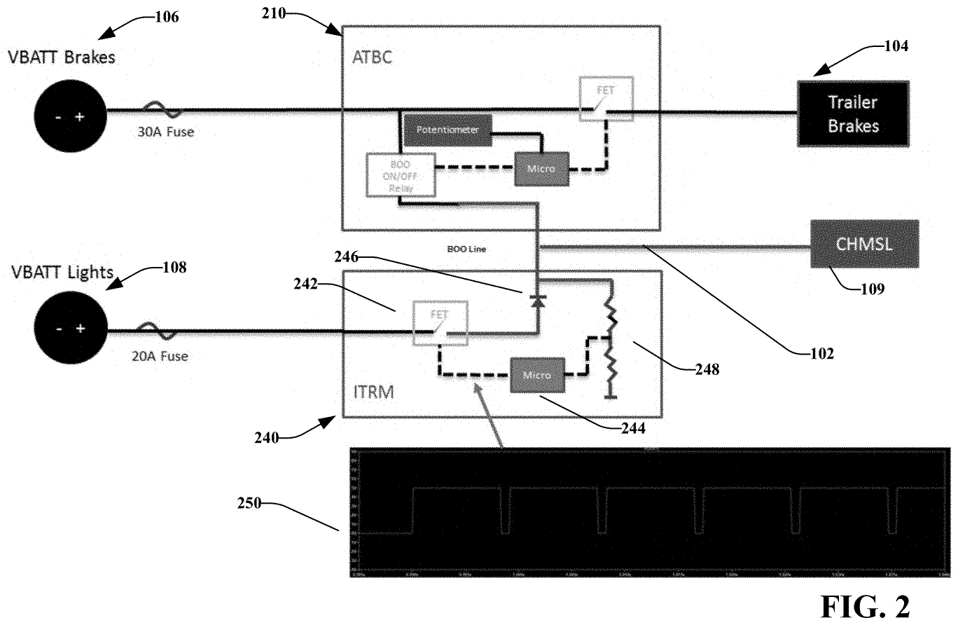

Turning to FIG. 2, there is a functional block diagram of a trailer system 200 including a trailer brake controller 210 and a trailer light controller 240. It is noted that like named components of system 100 and 200 may include similar aspects unless stated otherwise or context suggests a deviation. For instance, trailer brake controller 210 and trailer brake controller 110 may comprise the same or similar brake controllers. The trailer brake controller 210 may comprise any configuration, including, without limitation, those disclosed in U.S. Pat. Nos. 6,012,780; 6,068,352; 6,282,480; 6,445,993; 6,615,125; 8,746,812; 8,789,896; and 9,150,201, which are incorporated herein by reference. The system allows the trailer brake control module to work with the lighting module to prevent or substantially eliminate conflicts. The system may turn lighting off through the lighting module when the trailer brake controller is activating the applicable lighting. This may prevent an overload of the lighting system, trailer braking system or a combination of the foregoing. This may prevent the brakes of the trailer from being unintentionally initiated and may prevent the lighting from taking too much load.

The trailer light controller 240 may primarily include a power circuit 242, a processor 244, an anti-feedback circuit 246, and a sensing circuit 248. In embodiments, the anti-feedback circuit 246 may be connected in series to the power circuit 242 between the power circuit 242 and the BOO line 102. The anti-feedback circuit 246 may, for example, comprise a diode that prevents the flow of current from the brake power source 106 to the power circuit 242 when the manual braking interface is activated (e.g., when a user interacts with a potentiometer or the like.) In an aspect, the brake power source 106 may be greater than the lights power source 108. By preventing current feedback or flow to the power circuit 242 from the power source 106, the power circuit 242 may comprise a FET that does not need to handle the higher current feedback. As such, the FET may comprise a smaller FET than that of system 100. Further, while the configuration of the current sensing circuit 248 is described herein, it should be understood that nay configuration of current sensing circuit may be utilized. Any system can be used that will turn off the FET and not just as described herein. Further, while the current sensing circuit 248 is disclosed as being part of the trailer light controller 240, the current sensing circuit 248 could be part of the brake controller 210, in the alternative or in addition to being part of the trailer light controller 240.

In another aspect, the processor 244 (or 144) may drive the power circuit 242 during non-manual braking events. For instance, when the user applies vehicle brakes, the trailer light controller 240 may drive the power circuit 242. As an example, a switch may be closed to allow a FET of the power circuit 242 to apply a signal from the lights power source 108. The processor 244 may generate or apply a pulse-width modulated signal 250 to the power circuit 242.

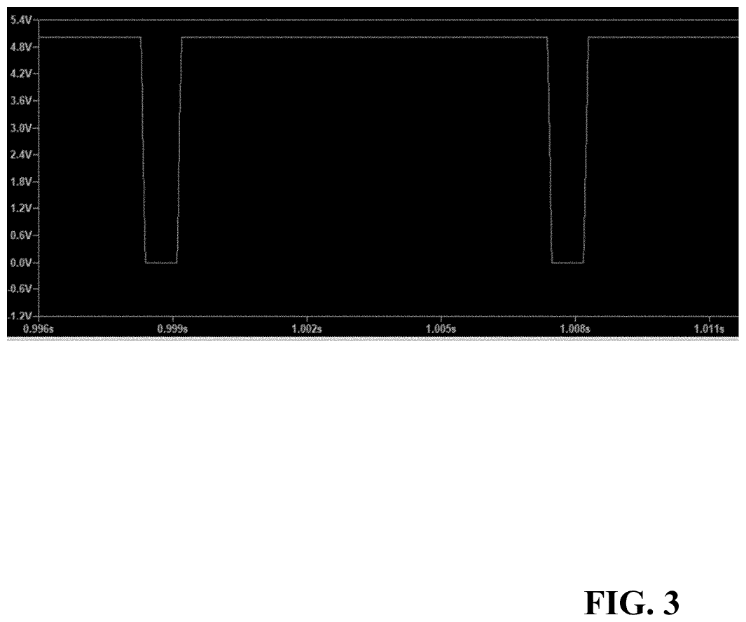

When not driving the FET, the trailer light controller 240 may send a voltage on the BOO line 102. The processor 244 may read or sample the BOO line 102 while the power circuit 242 is off, such as shown in FIG. 3.

In another aspect, the sensing circuit 248 may sense current flow or voltage through the BOO line 102. The processor 244 may monitor the current flow through the BOO line to determine if the BOO is on. For instance, if the voltage on the BOO line 102 is high (e.g., exceeds an upper threshold), then the processor 244 within sensing circuit 248 determines that the BOO is on and stops driving the power circuit 242. If the BOO line 102 is low, the processor 244 within sensing circuit 248 determines that the BOO line 102 is off (e.g., BOO relay 112 is open or in an off state) and continues to apply a voltage. In some of the embodiments, the sensing/detecting may occur during the off-time/off-state of the FET. In some embodiments, the FET is continuously sampled and while in the off state, the system performs the sensing/detecting described herein.

It is further noted that within sensing circuit 248, the processor 244 may monitor the current flow or voltage through the power circuit 242. If, for example, the current flow exceeds a threshold (e.g., 2 amps) then the processor 244 will shut off the power circuit 242. This represents some unknown error or incorrect connection. It is further noted that the processor 244 may monitor and record a history of errors, may generate error codes, or may reset the system 200 in response to detected errors. In another aspect, if power circuit 242 is already off, sensing circuit 248 will be active. If sensing circuit 248 is on, then the trailer light, such as the CHMSL, will be on and therefore power circuit 242 may be turned off if on as described above or stay off if already off. This may prevent the conflict from the trailer brake control module and lighting module.

As noted previously, to generally prevent the conflict between the trailer brake control module and the lighting module, if the VBATT light is greater than the VBATT brakes then the path through the power circuit 242 is avoided because BOO is detected on the sensing circuit 248.

In sum, the system will not initiate lighting if the light is already on (i.e., VBATT light is on) during off time of FET. The system detects the VBATT light is on and detects BOO when the on/off relay is on due to manual operation of the trailer brake controller 210, the additional light signal is turned off. This prevents the conflict between the trailer light controller 240 and the trailer brake controller 210 as described above. The present disclosure is particularly effective and applicable to the stop light system of the towed vehicle or accessories that may be operatively attached with the towing vehicle.

Further, if VBATT light is greater than VBATT brakes, diode 246 is sized such the CHMSL doesn't have the capacity to drive the trailer brakes.

In another aspect, the a trailer light controller 240 may identify whether one or more lights of the trailer system comprise an incandescent light source and may disable actions for a period of time if the light source is an incandescent light source. For instance, if the center-high mounted stop light 109 is an incandescent light source, trailer light controller 240 may disable actions after activation.

This may prevent the trailer light controller 240 from activating the lights/lighting system already activated by the brake controller 210. This prevents the lighting system from overheating and can prevent the towed vehicles brake from being unintentionally applied.

Further still it should be understood that the system may allow the stop light (or other applicable light) to turn on (or activate) using only the trailer light controller 140/240 (as applicable) only when the manual activation of the towed vehicle brakes on the brake controller 110/210 (as applicable) is inactive or off. The status of the manual activation of the towed vehicle brakes on the brake controller 110/210 may be sensed, such as by sensing circuit 248 (or any applicable portion thereof) such as through the current therein. This prevents the trailer light controller 140/240 from being overloaded so that it doesn't unintentionally apply the towed vehicle brakes and prevents the lighting system/lights of the towed vehicle from overheating.

It should be understood that the foregoing description is a description of an exemplary brake controller. The present teachings are not limited to the embodiment disclosed above. Any configuration of brake controller may be utilized without departing from the present teachings.

Modification of the invention will occur to those skilled in the art and to those who make or use the invention, including, without limitation, the values provided for the various elements disclosed above. It should be understood that such values are exemplary values and the present invention is not limited to those values. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

Although the embodiments of this disclosure have been illustrated in the accompanying drawings and described in the foregoing detailed description, it is to be understood that the present disclosure is not to be limited to just the described embodiments, but that the embodiments described herein are capable of numerous rearrangements, modifications and substitutions without departing from the scope of the claims hereafter. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define a blending system. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. The claims as follows are intended to include all modifications and alterations insofar as they come within the scope of the claims or the equivalent thereof.

1. A system comprising:
a trailer brake controller comprising a manual braking control; and,
a trailer light controller;
wherein the trailer brake controller comprises a brake on/off relay which responds to the manual braking control.

2. The system of claim 1 wherein the trailer brake controller is an electronic device that controls the brakes of a trailer.

3. The system of claim 1 wherein the trailer brake controller is included in a towing vehicle or in a trailer.

4. The system of claim 1 wherein a user interface component is included in the trailer brake system wherein the user interface component is in communication with the manual braking control in a towing vehicle or trailer and is configured to receive an activation instruction from the manual braking system when activated by a user.

5. The system of claim 4 wherein the user interface component is a potentiometer.

6. The system of claim 4 wherein the user interface component is configured to further communicate a signal to the brake on/off relay.

7. The system of claim 6 wherein the signal is one that closes the brake on/off relay thereby allowing the signal to further communicate with at least one light on a trailer.

8. The system of claim 1 wherein the trailer light controller comprises a power circuit, an anti-feedback circuit and a sensing circuit.

9. The system of claim 8 wherein the anti-feedback circuit is connected, in series, between the power circuit and the brake on/off relay.

10. The system of claim 9 wherein the anti-feedback circuit comprises a diode.

11. A process for using a trailer brake system comprised of:
a trailer brake controller; and,
a trailer light controller;
wherein the process comprises:
from a towing vehicle, initiating a braking signal to the trailer brake controller to apply a trailer's brakes;
wherein the braking signal is received by a user interface in the trailer brake controller which communicates the braking signal to the brakes of a trailer and communicates the braking signal to a brake on/off relay;
wherein the brake on/off relay, upon receiving the braking signal, closes, thereby sending a signal to at least one brake light on a trailer to indicate braking is being applied to the trailer and lighting the brake light.

12. The process of claim 11 wherein the user interface is a potentiometer.

13. The process of claim 11 wherein the trailer light controller comprises a power circuit, an anti-feedback circuit and a sensing circuit.

14. The process of claim 13 wherein the anti-feedback circuit is connected, in series, between the power circuit and the brake on/off relay.

15. The process of claim 14 wherein the anti-feedback circuit comprises a diode.

16. The process of claim 11, wherein, when the brake on/off relay is closed, the anti-feedback circuit in the trailer light controller prevents flow of current from the trailer brake controller to the trailer light controller.

17. The process of claim 11, wherein, when the braking signal is not present, the brake on/off relay opens and the brakes on the trailer are not applied and the brake light on the trailer is not activated.

18. The process of claim 17 wherein the trailer light controller communicates with and controls lights on the trailer.

19. The process of claim 18 wherein the lights on the trailer include brake lights on the trailer.

20. The process of claim 17 wherein the lights on the trailer include a center high mounted stop light (CHMSL).

21. A system comprising:
a trailer brake controller comprising a manual braking control; and,
a trailer light controller;
wherein the trailer light controller is configured to turn on a stop light of a trailer lighting system or towing accessory lighting system when the manual braking control is not activated.

22. The system of claim 21 further comprising a sensing circuit operatively coupled with either of the trailer brake controller and/or the trailer light controller, wherein the sensing circuit senses a status of the manual braking controller.

23. The system of claim 22, wherein the sensing circuit is integrated into the trailer light controller.
